(19) United States
(12) Patent Application Publication
(10) Pub. No.: US 2016/0133094 A1
(43) Pub. Date: May 12, 2016

(54) Split Reel Gaming Machine And Method of Gaming Using Split Reels

(71) Applicant: Gemini Digital Development, Inc., Las Vegas, NV (US)

(72) Inventors: Alfred Thomas, Las Vegas, NV (US); Benjamin T. Gomez, Las Vegas, NV (US); James P. Jackson, Henderson, NV (US); Robert Parviainen, Santa Monica, CA (US)

(21) Appl. No.: 14/937,709

(22) Filed: Nov. 10, 2015

Related U.S. Application Data
(60) Provisional application No. 62/077,503, filed on Nov. 10, 2014.

(51) Int. Cl. G07F 17/32

(52) U.S. Cl. CPC G07F 17/3267; G07F 17/3246; G07F 17/3213; G07F 17/3209

(57) ABSTRACT

Gaming machines and methods of presenting a game on a gaming machine include receiving a monetary value from the player at the gaming machine as credits usable at the gaming machine and presenting a plurality of slot reels on an electronic display, the plurality of slot reels each comprising a plurality of symbols. It is determined whether a split feature is triggered in the wagering game via a random number generator. When the split feature is triggered, one or more of the plurality of slot reels is split into two or more slot reels. An outcome of the symbols is randomized on the plurality of slot reels via the random number generator and the symbols on the slot reels are displayed to spin. The symbols are evaluated on the plurality of slot reels for winning outcomes; and monetary awards are provided to the player for the winning outcomes.

### CROSS REFERENCE TO RELATED APPLICATION

This application claims priority to U.S. Provisional Application No. 62/077,503 which was filed on Nov. 10, 2014, the contents of which are hereby incorporated by reference.

### BACKGROUND

1. Field of the Invention

The present invention relates to gaming machines and methods of playing and presenting games.

2. Related Art

Game players continue to seek new and exciting games. Relative to wagering games, game players enjoy games which present new and exciting ways to obtaining winning awards. One prior art method of increasing player interest in the game is to increase the number of pay lines in a slot game. By increasing the number of paylines, the players' chances of receiving a winning outcome are increased and the player is presented with additional options to consider when playing. This increases player excitement.

Another proposed feature in slot games as implemented on gaming machines is wild symbols. The wild symbol is placed on a reel, either physical or electronic, and can be assigned to a reel position. As a result, the wild symbol increases the player's perceived likelihood of receiving a winning outcome, and increases player involvement in the game when evaluating winning outcomes. However, as with increasing the number of pay lines, players have become accustomed to a wild symbol located at a fixed location on a reel.

Another known game feature is referred to a sticky wilds. However, this game features is old and known and no longer spurs player's interest. In addition, it lacks certain features present in the present gaming machine and game combination.

However, these prior art features are now well established and known. As a result, players may not be attracted to games offering these well-known features. Therefore a new and exciting game is with new game features disclosed below.

### SUMMARY

The disclosed embodiments disclose a gaming machine, gaming system, and method of presenting a game with new game features. In one embodiment, a gaming machine and associated game is provided that splits or clones one or more of the reels in the game symbol array, thus making the array of symbols larger.

According to one embodiment a gaming machine comprises a wager accepting device, at least one electronic display, at least one player input device, a controller, and a memory. The wager accepting device may comprise a coin, bill, or ticket acceptor configured to receive a monetary value at the gaming machine. The at least one electronic display may be configured to present game information including a wagering game to a player. The at least one player input device may be part of or separate from the display, and may be configured to accept player input regarding the wagering game. The controller may include one or more random number generators in communication with the player input device, and is configured to execute machine-readable code. The memory in is communication with the controller, and may be configured to store the machine-readable code. The machine readable code is executable by the controller and is configured to cause the gaming machine to present a wagering game.

In some embodiments, the wagering game may comprise receiving a coin, bill, or ticket comprising a monetary value from the player at the gaming machine as credits usable at the gaming machine and accepting an input from the player via the at least one player input device to accept a wager on a wagering game or enable game play. A plurality of slot reels may be presented on the electronic display. The plurality of slot reels each comprise a plurality of symbols. A determination may be made whether a split feature is triggered in the wagering game via the random number generator. When the split feature is triggered, one or more of the plurality of slot reels may be split into two or more slot reels.

An outcome of the symbols on the plurality of slot reels may be randomized via the random number generator. For example, the electronic display may show the slot reels spinning and producing a random outcome of symbols. The symbols on the plurality of slot reels are evaluated for winning outcomes. When winning outcomes are evaluated, monetary award is provided to the player for the winning outcomes based on the wager amount.

In further embodiments, the splitting of one or more of the plurality of slot reels may comprise splitting one or more slot reels into two or more identical slot reels. This may be referred to as cloning one or more of the slot reels. The splitting of one or more of the plurality of slot reels may also comprise increasing a height of one or more of the slot reels so that a number of symbols displayed on the reel is increased. The symbols may be evaluated in an all way any way pay evaluation.

In other embodiments, a gaming machine comprises a wager accepting device, at least one electronic display, at least one player input device, a controller, and a memory. The wager accepting device may comprise a coin, bill, or ticket acceptor configured to receive a monetary value at the gaming machine. The at least one electronic display may be configured to present game information including a wagering game to a player. The at least one player input device may be part of or separate from the display, and may be configured to accept player input regarding the wagering game. The controller may include one or more random number generators in communication with the player input device, and is configured to execute machine-readable code. The memory in is communication with the controller, and may be configured to store the machine-readable code. The machine readable code is executable by the controller and is configured to cause the gaming machine to present a wagering game.

A coin, bill, or ticket comprising a monetary value from the player at the gaming machine is received as credits usable at the gaming machine. An input from the player is accepted via the at least one player input device to accept a wager on a wagering game or enable game play. The gaming machine may present a plurality of slot reels on the electronic display. The plurality of slot reels may each comprise a plurality of symbols. The plurality of symbols includes one or more trigger symbols.

In one embodiment, the gaming machine randomly assigns the one or more trigger symbols an active or an inactive status via the random number generator. An outcome of the symbols on the plurality of slot reels may be randomized via the random number generator and the electronic display may show the slot reels spinning. When the one or more trigger symbols that has the active status is displayed on the electronic display, the slot reel on which the active trigger symbol is displayed may be split into two or more slot reels. The symbols on the plurality of slot reels for may be evaluated for winning outcomes. When winning outcomes are evaluated, monetary award may be provided to the player for the winning outcomes based on the wager amount.

In some embodiments, the splitting the slot reel comprises splitting the slot wheel on which the active trigger symbol is displayed into two or more identical slot reels. In other embodiments, the splitting the slot reel comprises increasing a height of the slot wheel on which the active trigger symbol is displayed. The gaming machine may evaluate the symbols in an all way any way pay evaluation.

In one embodiment, the active trigger symbol is reproduced on each reel resulting from splitting the slot reel on which the active trigger symbol is displayed. The active trigger symbol may be reproduced at a different location on each reel resulting from the splitting. The active trigger symbol may be overlaid and fixed on a symbol position while remaining symbols of the reels spin.

In some embodiments, there is a method of presenting a game on a gaming machine comprising at least one electronic display, a wager accepting device, at least one player input device, and a controller including at least one random number generator. The method may comprise receiving a wager from a player at the gaming machine via the wager accepting device and accepting an input from the player via the at least one player input device to accept a wager on a wagering game or enable game play.

A plurality of slot reels on the electronic display may be presented. The plurality of slot reels may each comprise a plurality of symbols. The method further comprises determining whether a split feature is triggered in the wagering game via the random number generator. When the split feature is triggered in the wagering game, one or more of the plurality of slot reels may be split into two or more slot reels. An outcome of the symbols on the plurality of slot reels may be randomized via the random number generator and the slot reels may be shown to spin on the electronic display.

The symbols on the plurality of slot reels may be evaluated for winning outcomes. When winning outcomes are evaluated, a monetary award may be provided to the player for the winning outcomes based on the wager amount.

In some embodiments, the controller selects the split feature for none or one or more of the plurality of slot reels based on an outcome generated by the random number generator. In other embodiments, the plurality of symbols may comprise one or more trigger symbols. When the one or more trigger symbols are displayed on one of the plurality of slot reels, the split feature is applied to each of the slot reels displaying the trigger symbol.

The one or more trigger symbols may be randomly assigned an active or an inactive status. The split feature may be applied only where the trigger symbol is assigned the active status. In some embodiments, the split feature may comprise splitting one or more slot reels into two or more identical slot reels. In other embodiments, the split feature may comprise increasing a height of one or more of the slot reels. The method may also comprise evaluating the symbols in an all way any way pay evaluation.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is an exemplary gaming machine screen display presenting the slot game disclosed herein.

FIG. 2 is an exemplary gaming machine screen display presenting the slot game disclosed herein.

FIG. 3 is an exemplary gaming machine screen display presenting the slot game disclosed herein.

FIG. 4 is an exemplary gaming machine screen display presenting the slot game disclosed herein.

FIG. 5 is an exemplary gaming machine screen display presenting the slot game disclosed herein.

FIG. 6 is an exemplary gaming machine screen display presenting the slot game disclosed herein.

FIG. 7 is an exemplary gaming machine.

FIG. 8 is an exemplary networked gaming system configured to implement the method disclosed herein.

FIG. 9 is an operational flow diagram of an example method of operation.

FIG. 10 is an operational flow diagram of an example method of operation.

FIG. 11 is an exemplary computer or mobile device.

### DETAILED DESCRIPTION OF EMBODIMENTS

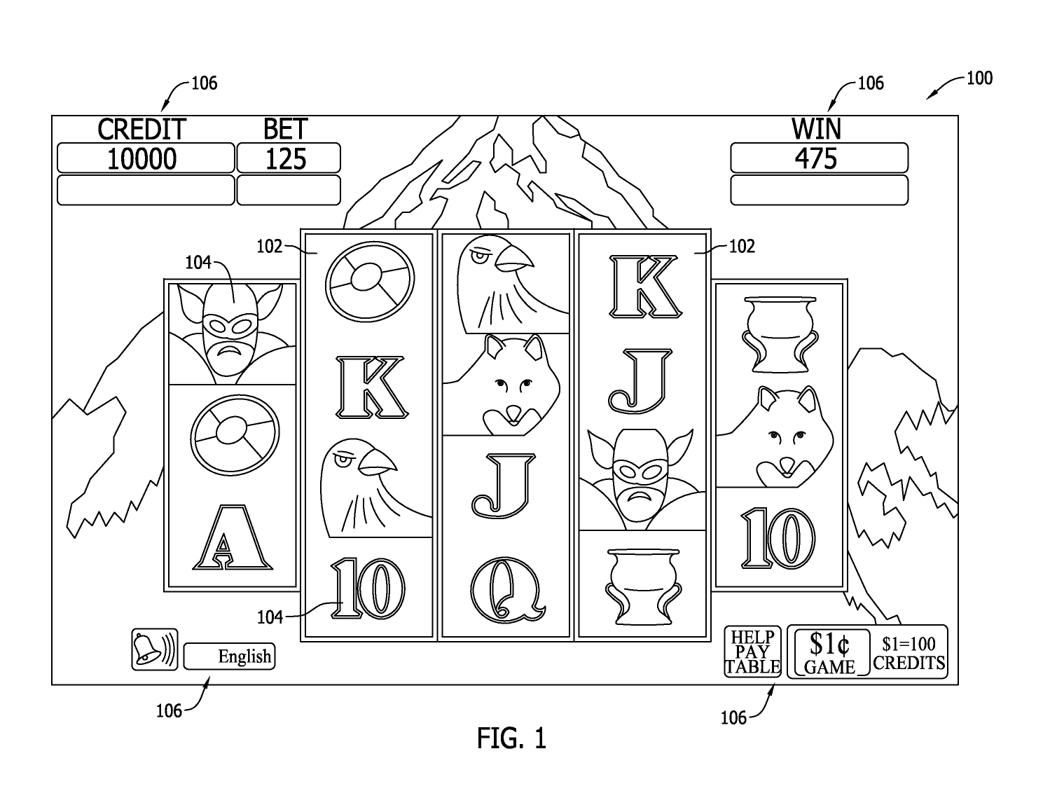

FIG. 1 is an exemplary gaming machine screen display presenting a slot game disclosed herein. A screen display 100 may be presented to a player as part of game play on a gaming machine. The Screen 100 displays two or more reels 102, which may be physical reels or computer generated reels. On the reel 102, or represented as video images on the reel 102, are symbols 104. The symbols 104 on each reel 102 are generated based on one or more random number generators during game play. Game data 106 is displayed on the screen 100 to provide information to the player regarding for example game play, credits, bet amounts, game play denomination, and an option for the player to obtain help or game instructions.

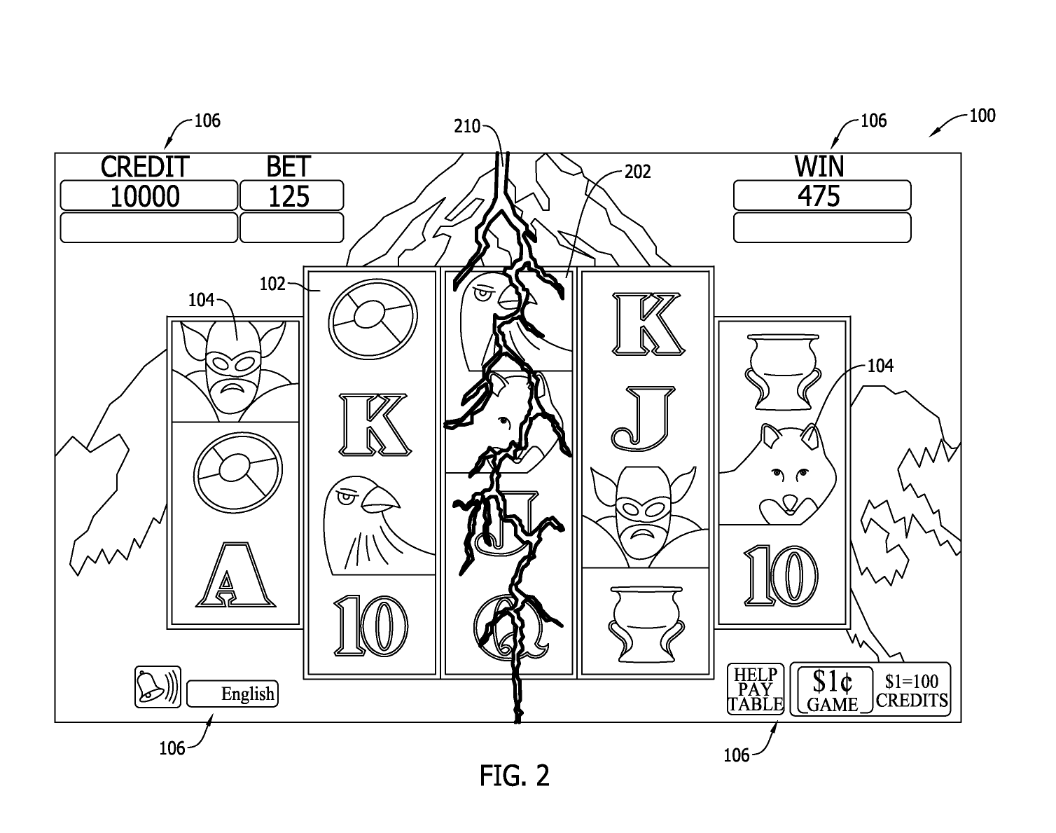

In one exemplary embodiment of a game, one of the reels 102 is configured to split into two reels 102 upon the occurrence of a triggered feature. The feature may be triggered by an outcome of a random number generator, based on the display of a predetermined symbol 104 on one of the reels 102, or the like. FIG. 2 shows an exemplary gaming machine screen display where a split feature is triggered. In FIG. 2, a center reel 202 of the reels 102 is triggered to be split into two reels. In one embodiment, the screen 100 may display an indicator 210 or a sound may be presented informing the player that the split feature has been triggered. The indicator may take any form, such as a lightening bolt, lava flow, rectangle around reel, flashing lights, highlighting, color application, color reverse, or any other indication to the player.

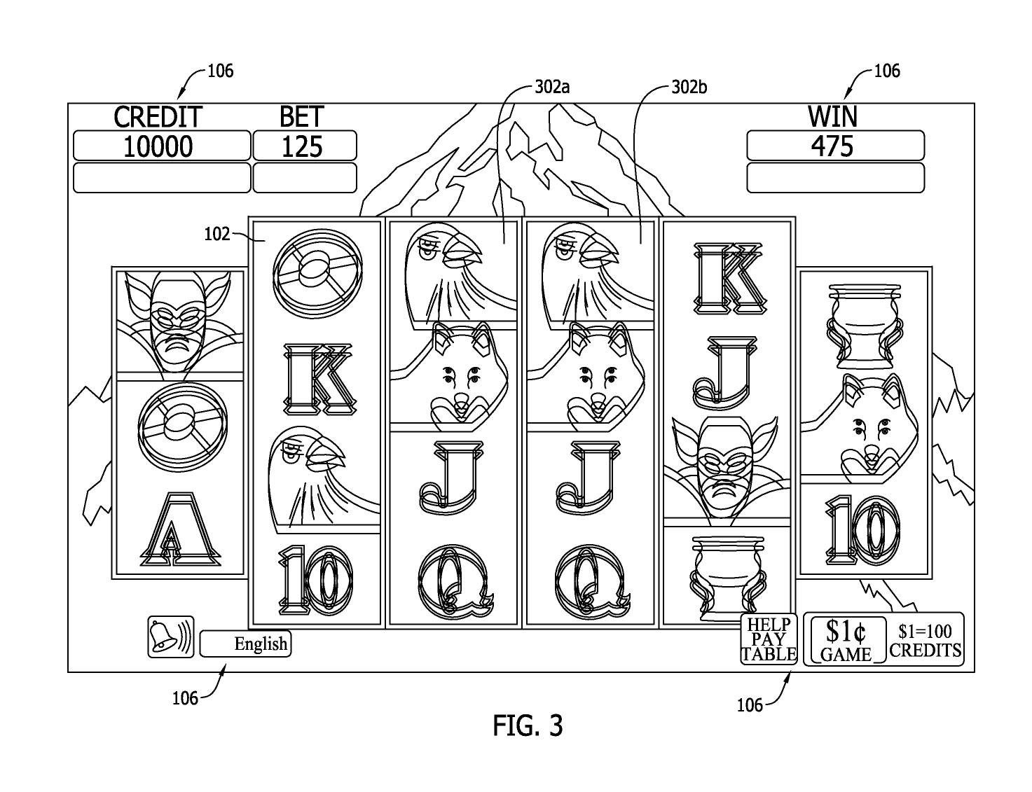

When the split feature is triggered, the selected reel 102 may be split into two identical reels. It is also contemplated that the reels need not be identical, but could be split into different symbols or a pre-determine symbol pattern. As shown in FIG. 3, the reel 202 of FIG. 2 is split into two identical reels 302a, 302b. The array of reels 102 included the split reels 302a, 302b may then be spun to determine a game outcome as in a typical slot game. It is also noted that the split feature to split one of the reel 102 into two reels may also be implemented after or during the spinning of the reels 102.

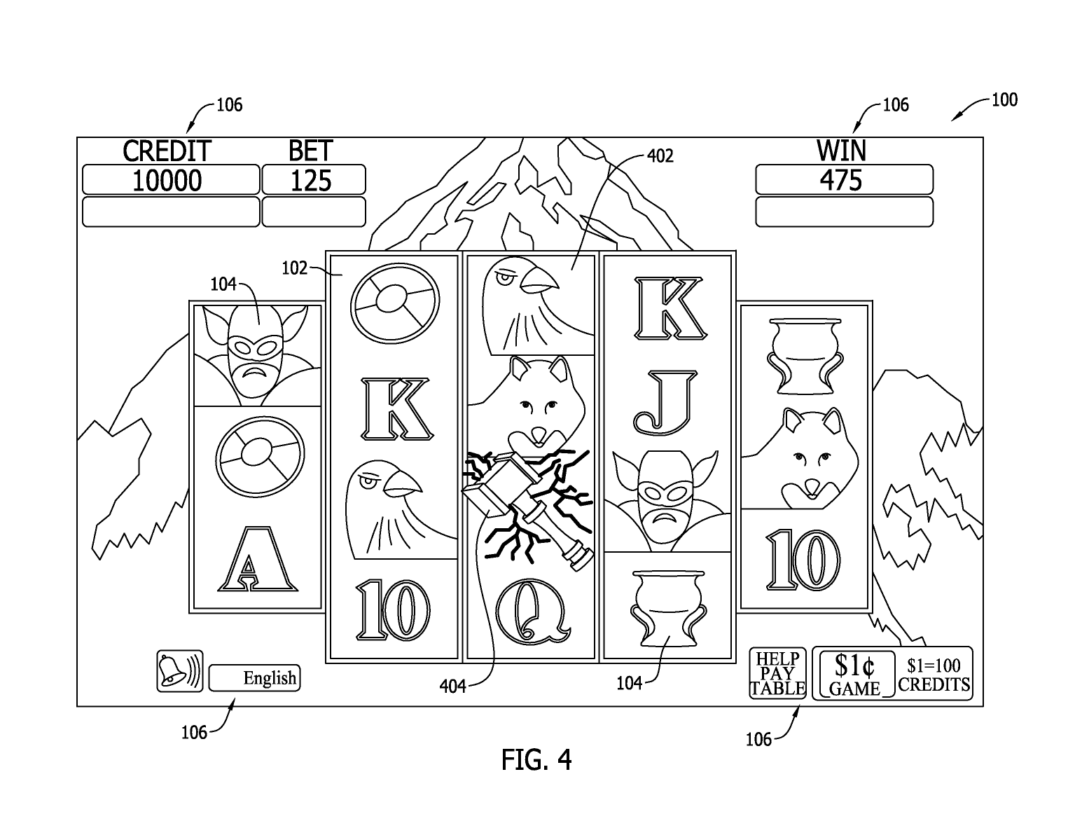

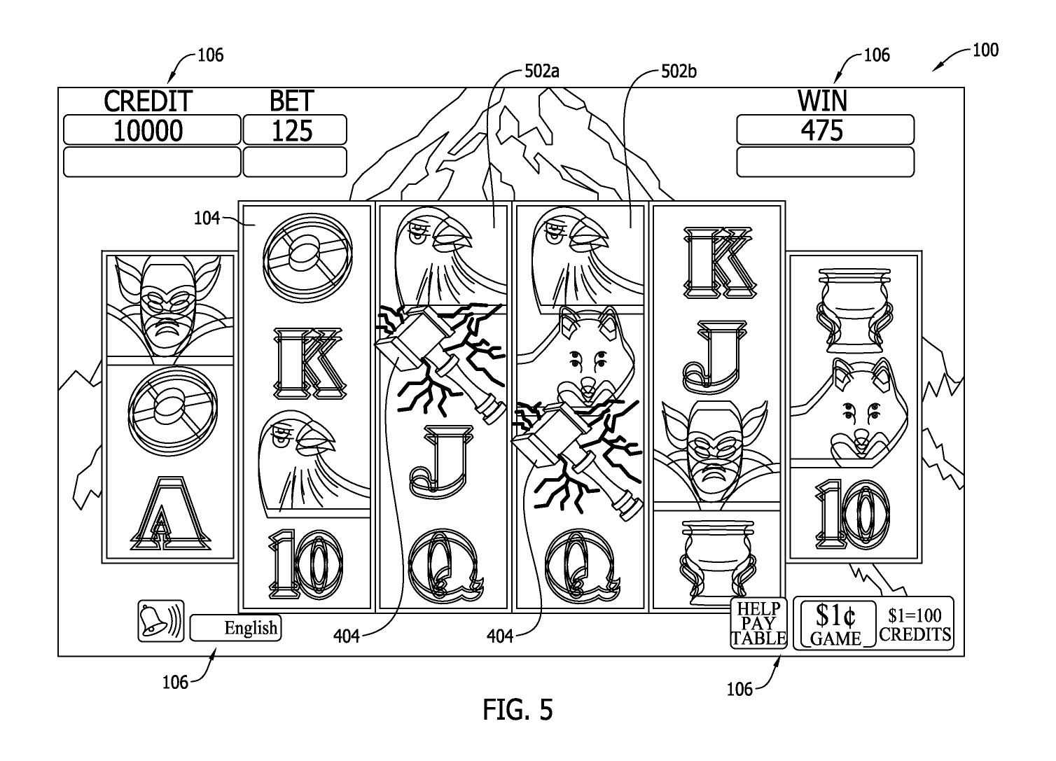

FIG. 4 shows another exemplary gaming machine screen display where a split feature is triggered. In this embodiment, the split feature is triggered by the display of a predetermined symbol 404. In this present example, the predetermined symbol is a hammer 404 which is displayed on the center reel 402. As a result of the display of the predetermined symbol, the reel 402 is split into two reels 502a and 502b, as shown in FIG. 5. The reels may then spin as in a traditional slot game to determine a whether there is a winning game outcome. A wager amount may also determine or control whether the split feature can occur such that a minimum wager may have to be made by the player before the split feature will occur.

In this embodiment, the center reels 502a, 502b are configured to be identical to one another. Further, the predetermined symbol 404 may be reproduced on both the reels 502a, 502b. Here, the predetermined symbol 404 is reproduced on the reels 502a, 502b in different positions on the reels. In some embodiments, the predetermined symbols 404 may act as a “wild” symbol. As shown in FIG. 5, the predetermined symbols 404 may be displayed at a fixed location while the remaining symbols of the reels spin to determine an outcome of the slot game. The new reel could also be populated with symbols selected at random.

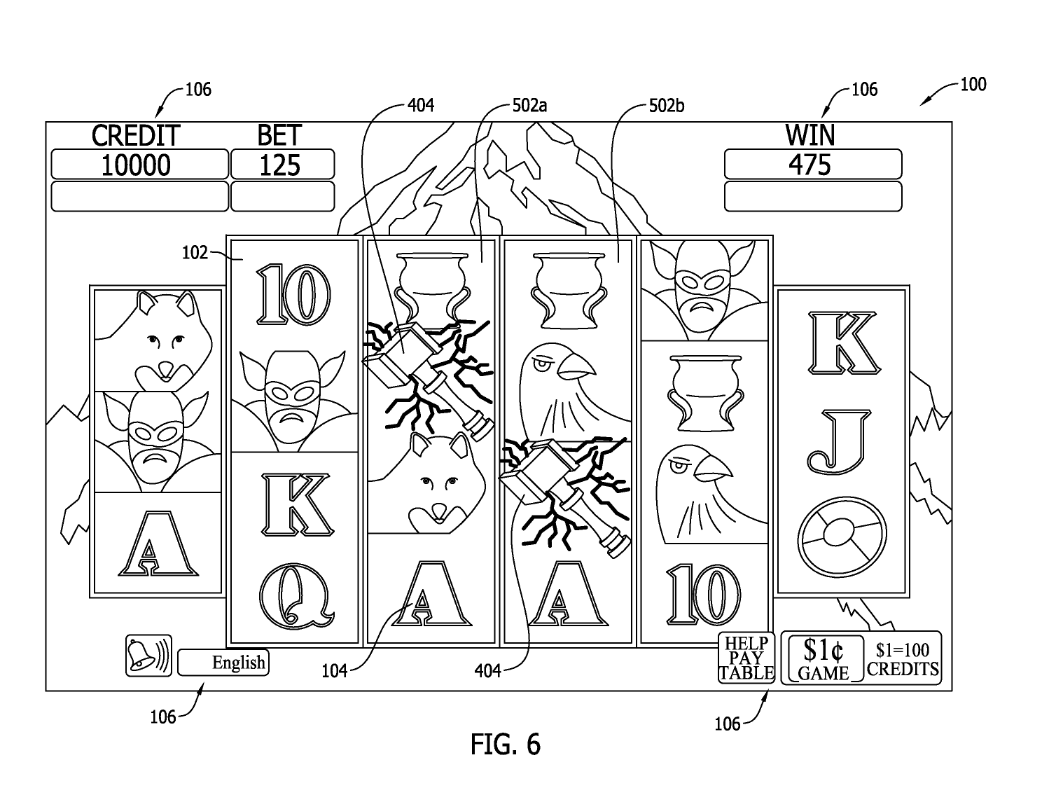

Once the reels have stopped spinning, as shown in FIG. 6, the game processor may evaluate the symbols along one or more pay lines. Based on the evaluation, winnings may be paid to the player, or the player's wager may be collected. The split feature may be incorporated with an all way, any way pay evaluation or any other known pay line evaluations.

The feature may also be incorporated on any array size of reels and displayed symbols such as 5 by 3, 5 by 4, 6 by 4, 3-4-4-4-3, etc. For example, if the base array is a 5×4 (4-4-4-4-4) array, and the second reel is triggered to split and increase in size, the resulting array may be 4-5-5-4-4-4. Thus would result in two columns in the array having one more symbol that the other four columns which would in turn increase the number of pay-lines and increase the opportunity for the player to receive a winning outcome. Awards may then be evaluated using all possible 6400=4*5*5*4*4*4 ways.

Other variations are also possible. For example instead of or in addition to splitting the reel upon the occurrence of a trigger, the reel or split reels may also increase in height. That is, the portion of the reel displayed on the screen may be increased to display more symbols than the original reel. In other embodiments, more than one reel may be triggered to split into two reels. Further, one or more reels may be triggered to split, while one or more other reels may be configured to increase in height, while one or more other reels may be configured both to split and increase in height. Thus, additional columns or rows, or both, may be created. In yet other embodiments, a reel that is triggered to be split may be split into more than two reels. That is, the split reel may result in three or four reels in place of the originally split reel.

In some embodiments where a predetermined trigger symbol is used to trigger the split reel feature, the predetermined trigger symbol may be set to be active or inactive. When the trigger symbol is inactive, it may not trigger a split reel feature, but may function only as a wild symbol. When the symbol is active, it may trigger the split reel feature. In some embodiments, there may be multiple trigger symbols where only a subset of the trigger symbols are active. The subset of active trigger symbols may be randomly selected. The random selection of the subset of active trigger symbols may be repeated after each game or at a set or random periodic basis.

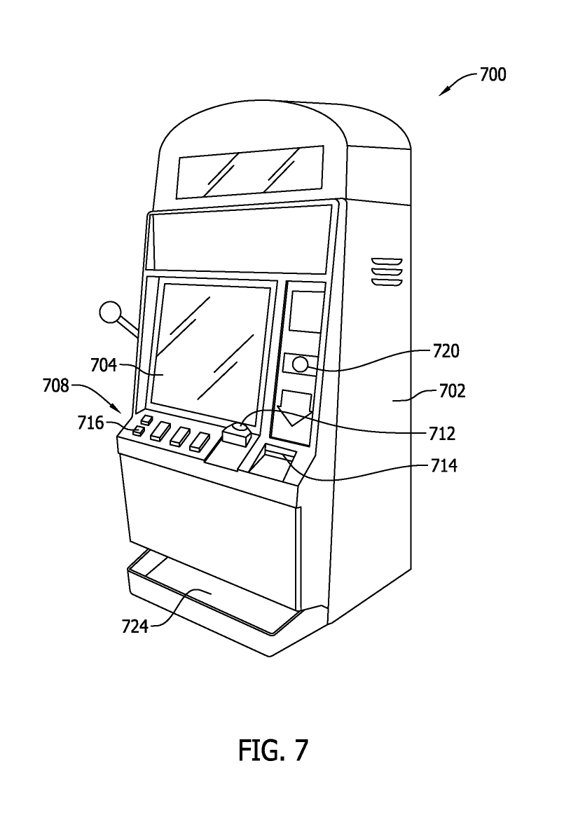

The above described game and variations may be presented on a gaming machine. One configuration of a gaming machine 700 is illustrated in FIG. 7A. As illustrated, the gaming machine 700 generally comprises a housing or cabinet 702 for supporting and/or enclosing various components required for operation of the gaming machine. In the embodiment illustrated, the housing 702 includes a door located at a front thereof, the door capable of being moved between an open position which allows access to the interior, and a closed position in which access to the interior is generally prevented. The configuration of the gaming machine 700 may vary. In the embodiment illustrated, the gaming machine 700 has an “upright” configuration. However, the gaming machine 700 could have other configurations, shapes or dimensions (such as being of a “slant”-type, “bar-top” or other configuration as is well known to those of skill in the art).

The gaming machine 700 preferably includes at least one display device 704 configured to display game information. The display device 704 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 704 may be capable of projecting or displaying a wide variety of information, including images, symbols and other indicia or information associated with game play, game promotion or other events.

As described in more detail below, the gaming machine 700 is preferably configured to present one or more games upon a player making a monetary payment or wager. In this regard, as described in more detail below, the gaming machine 700 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 700 includes means for returning unused monetary funds and/or dispensing winnings to a player.

The gaming machine 700 preferably includes one or more player input devices 708 (such as input buttons, plunger mechanisms, a touch-screen display, joystick, touch-pad or the like). These one or more devices may be utilized by the player to facilitate game play, such as by providing input or instruction to the gaming machine 700. For example, such input devices 708 may be utilized by a player to place a wager or a side wager, cause the gaming machine 700 to initiate a game, to indicate cards to be held or discarded, to “cash out” of the gaming machine, or to provide various other inputs. The game and gaming machine disclosed herein may be optionally equipped with a side wager.

In one preferred embodiment, the gaming machine 700 includes at least one microprocessor or controller for controlling the gaming machine, including receiving player input and sending output signals for controlling the various components of the machine 700 (such as generating game information for display by the display 704). The controller may be arranged to receive information regarding funds provided by a player to the gaming machine, receive input such as a purchase/bet signal when a purchase/bet button 716 is depressed, and receive other inputs from a player. The controller may be arranged to generate information regarding a game, such as generating game information for display by the at least one display 704 (such as information representing images of displayed cards), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 700 may also include one or more random number generators for generating random numbers, such as for use in selecting cards and for presenting the game in a random fashion.

Preferably, the controller, such as a processor, is configured to execute machine readable code or instructions which are configured to implement the method of game play of the invention. For example, the controller of the gaming machine 700 may be configured to detect a wager, such as a signal from a player's depressing of the “bet one” button. Upon such an event and/or the player otherwise signaling the gaming machine to present the game, the controller may be configured to cause cards to be dealt/displayed on the at least one display 704. The controller may accept input from a player of a request to split, buy insurance, obtain additional cards, activate slot reels, or the like via the one or more player input devices 708 of the gaming machine 700.

The gaming machine 700 may be configured to generate and present games in a stand-alone manner or it may be in communication with one or more external devices at one or more times. For example, the gaming machine 700 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 700 is configured to present one or more wagering games. Thus, the gaming machines 700 is preferably configured to accept value, such as in the form of coins, tokens, paper currency or other elements or devices representing value such as monetary funds. For example, as illustrated in FIG. 7, the gaming machine 700 might include a coin acceptor 712 for accepting coins. Of course, associated coin reading/verifying devices and coin storage devices may be associated with the gaming machine 700 if it is configured to accept coins. Likewise, the gaming machine 700 might include a media reader 714. Such a reader may be configured to accept and read/verify paper currency and/or other media such as tickets. Of course, in such event the gaming machine 700 may further be configured with one or more paper currency or ticket storage devices, such as cash boxes, and other paper currency or media handling devices (including transport devices).

The gaming machine 700 might also be configured to read FOBs, magnetic stripe cards or other media having data associated therewith and via which value or funds may be associated with the gaming machine 700.

In one embodiment, the gaming machine 700 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 700 dispensing coins to a coin tray 724. In another embodiment, funds may be issued by dispensing paper currency. In yet another embodiment, a player may be issued a media, such as a printed ticket, which ticket represents the value which was paid or cashed out of the machine.

The gaming machine 700 may also include a player tracking device, such as a card reader and associated keypad 720. Such player tracking devices are well known and may permit the game operator to track play of players of the gaming machine. The tracked play may be utilized to offer player bonuses or awards.

It will be appreciated that the gaming machine illustrated in FIG. 7 is only exemplary of one embodiment of a gaming machine. For example, it is possible for the gaming machine to have various other configurations, including different shapes and styles and having different components than as just described.

For example, it is possible for the base game to be presented on a computing device, including at a home or office computer, a kiosk or other types of devices. For example, the game might be presented via an application running on a computing device, or in a server-based or “Internet” environment. In one embodiment, a player might log in to a casino server and the controller of the casino server may cause game information to be delivered to the player's computer and then be displayed on a display of the player's computer. In this regard, it will be noted that the term “controller” may comprise more than one device. For example, in a server-based environment, a controller at a server may generate game information and transmit that information to a local controller at a gaming machine. The local controller at the gaming machine may then cause game information to be displayed on the display of the gaming machine. The games of the invention could also be presented by or at hand-held devices, such as PDAs, cellular phones, tablet computing devices or the like.

A casino may have numerous gaming machines 700, possibly located on a casino floor or in other locations. Of course, such gaming machines 700 might be used in other environments, such as an airport, a bar or tavern or other locations.

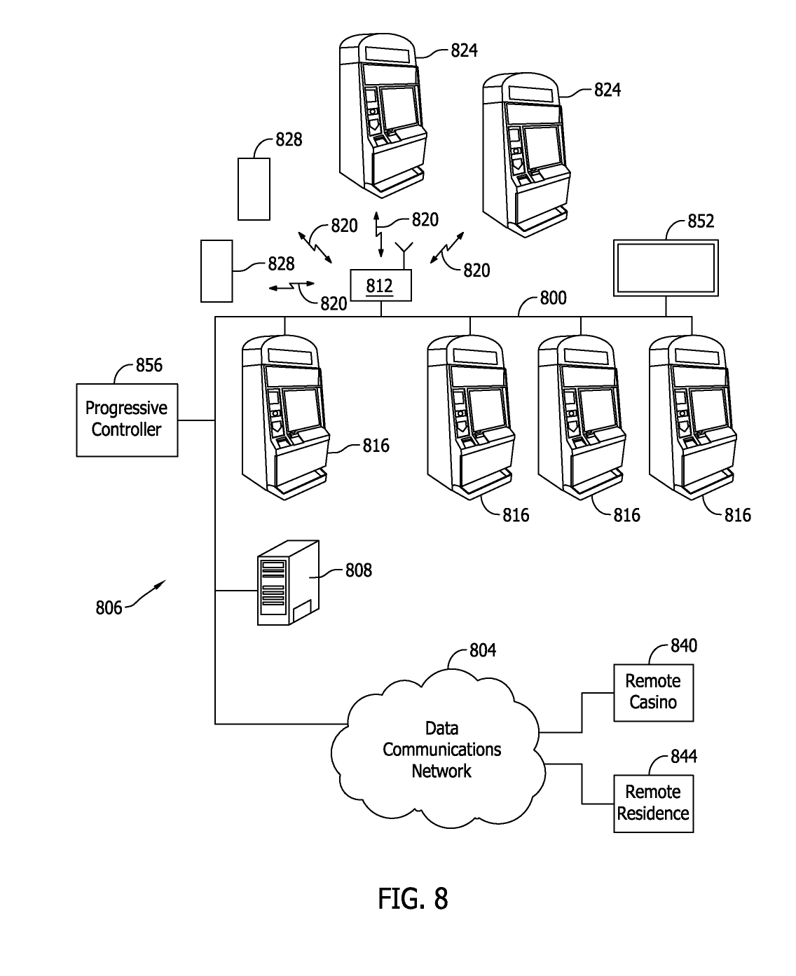

FIG. 8 is a block diagram of an example gaming system with a server based network. The communications network 800, 804 connects to multiple devices as discussed below to enable communication between devices. The network 800, 804 may be any type network capable of exchanging data between devices. The network may include a local network 800 and an external network 804 such as for example the Internet, or an Intranet with appropriate security mechanisms. The wagering game network may include other network devices, such as one or more servers which may comprise accounting servers, wide area progressive servers, player tracking servers, game content servers, or any other type server.

In this embodiment the gaming establishment at the top of the figure includes a network 800. As shown, the gaming network includes gaming machines 816 connected to the network 800 via a wired connection.

The network 800 may include a wireless device 812 capable of communicating over a wireless link 820 with one or more wireless gaming machines 824 or hand held gaming devices 828 A wagering game server 808 may serve wagering games on the gaming machines over the local area network 800 and function as a remote controller for the wagering games as described above.

The wagering network includes hardware and memory storing machine readable instructions and machine readable code for performing the operations described herein. Those of ordinary skill in the art will appreciate that each gaming establishment may include additional local area networks such which may serve to connect many other wagering games. Alternatively, multiple servers 808 may be used for the functions of the wagering game server which provide game content to the gaming machines 816, 824, 828.

The local area network 806 may be any type of suitable property LAN configuration including, for example, a dedicated hardwired property LAN or a wireless property LAN. The local area network 806 may be configured in any configuration or topology.

The local area network 806 includes wired communication links 800 and wireless communication links 820. In this example configuration, the stand-alone gaming machines 816 communicate with the network 802, 808 via the wired communication links as shown. The stand-alone gaming machines 828 as well as the handheld gaming devices 828 communicate with the network 800, 808 via the wireless communication links 820. One or more wireless communication devices 812, with associated antennas, enables wireless communication. Other combinations of wired and wireless connections to different gaming machines may be used. The wired and wireless communication links may employ any suitable connection protocols such as Bluetooth, IEEE 802.11, Ethernet, or any other format or standard. The network 800, 808 may be configured to enable downloading of instruction sets (software) for games, game configuration data, game outcomes, from the central server(s) such as the server 808 to the gaming machines, and to enable uploading or downloading of marketing and operations data from the gaming terminals to the central server.

As shown at the bottom of FIG. 8, the game server 808 or network 800 may also serve wagering game devices and/or distribute content to devices located in other gaming establishment 840 or at other locations 844 such as a residence.

The server 808 may be any type computer capable of executing programs or instruction sets for controlling gaming machine, such as slot machines, video slots, or video poker machines, and communication with wireless devices. Although shown as a single server, numerous servers may be used. In such embodiments, the gaming machines 816, 824, 828 may each be a simple input/output terminal with regard to the functions controlled by the server 808. For example, the random selection of outcomes for the basic game and any bonus game may be functions performed by the server 808 and subsequently provided to a gaming machine. Functions that are not provided by the server 808, such as control of the local lights, sounds, and displays of the gaming machine, are handled by the local CPU within the gaming machine.

In this embodiment, a progressive or accumulated jackpot system is provided that includes a video or other type display 852 that is coupled to the network 800, 808. The display 852 is viewable by a number of players to present a total jackpot that is available for award upon receipt of a predetermined outcome. This type event may be referred to as community based events accessible from games on the gaming machines or from remote locations 840, 844 or gaming devices 828. For example, the display 852 may be used to show a current progressive jackpot or jackpots which players playing different gaming machines may be eligible to win. The display 852 may be any type display.

In one embodiment, the community event is a progressive award or jackpot, which is preferably linked with other gaming machines via the network 800, 808 and/or the network 804. The entire progressive award or jackpot may be won upon the occurrence of a certain outcome of the game.

The server 808 may also operate one or more progressive awards concurrently with the basic game and/or bonus games. As explained above, such progressive awards are funded by appropriating a percentage of the coin-in from participating gaming machines. To be eligible to win the progressive award, the player may be required to make a progressive award side wager or make a wager satisfying predetermined criteria, e.g., a maximum wager or a wager covering all available paylines in the basic game. Then, upon occurrence of jackpot-won event in the form of either a “mystery” event or one or more predetermined outcomes in the basic game and/or bonus game, the player is awarded the progressive jackpot in addition to any regular prize or award resulting from the basic game and/or bonus game. The jackpot-won event may, for example, be the appearance of a predetermined scatter symbol during the basic game. A basic game menu may be part of the game disclosed herein and include several options for a player, including picking games, progressive options, and side bet options. Other community events may include a community bonus game, a bonus prize shared by multiple players, a multiplier award or other community features. Such a community event may interrupt the game play on the gaming machine 816 and use other mechanisms such as the display 852 to show graphics or video relating to the community event. In this example embodiment, each one of the players who are currently playing wagering games on the gaming machines participates in the community event according to an eligibility criteria such as time-based eligibility that each gaming machine determines locally. In this example, a community event or progressive controller 856 associated with the display 852 and progressive system continuously runs a process to determine if the community bonus should occur, using its random number generator (RNG) and monitor coin-in or wagers to increment the amount on the display. For example, controller 856 determines if the community event is triggered. If the controller 865 determines that the community event is triggered or won, then it will issue an invitation to the gaming machines. Because each of the wagering games on the gaming machines keeps track of the current eligibility of the respective games being played, each of the gaming machines makes a decision whether it will allow the player to participate in the community event, and at which multiplier any bonuses or prizes resulting from the community event will be awarded to the player. It is to be understood that a server such as the server 808 or a master gaming machine may be used for the controller 856.

The server 808 includes a storage device that contains software instruction sets for different wagering games which may be loaded onto a memory of gaming machines. It is to be understood that different parts of the instruction sets may be stored on the memory with other parts of the instruction sets stored on the individual gaming machines. For example, the gaming machines may store part of the instruction sets in the form of modules relating to graphics files, audio/sound files, and certain game functions and operations such as player greetings or instructions. The stored instructions sets are mated with the remainder of the instruction sets loaded from the memory over the network 800.

Part or all of the software instruction set for wagering games may be sent to the various gaming machines via the wired communication links 800 or the wireless communication links 820. The wagering games may be stand alone or may offer eligibility or access to progressive awards or support other community events with other gaming machines on the network 800 or external networks 804.

The server 808 in this example stores a number of wagering games in the storage device. It is to be understood that part of the software to support the wagering games may already reside on the system memory of the gaming machine. For example, the modules responsible for RNG, audio and/or video drivers, etc. may reside on the system memory of the gaming machine. Other components of the instruction set of the game such as graphics files, audio files etc. may also reside in the storage device. Some or all of the instruction set may be loaded via the external I/O circuit from the network 800 such as from the storage device of the server 808. In this manner, the gaming machine may be used to play different games without requiring manual delivery of instruction sets different games to the gaming machine.

For example, a player may request a certain wagering game based on an initial display of a menu of wagering games displayed by the gaming machine. The menu may include some or all available wagering games stored on the server 808. Other background graphics and/or videos may be displayed on the primary display or the secondary display of the gaming machine to attract players to the gaming machine. The secondary display may be electronic or a secondary game to present a secondary game outcome. Based on the menu displayed, a player may select the desired game via a player input device such as push buttons or touch screen buttons 708 (FIG. 7). Further, an operator of the casino may use the server 814 to load wagering games to different gaming machines based on popularity, location, time interval, special events, schedule, etc.

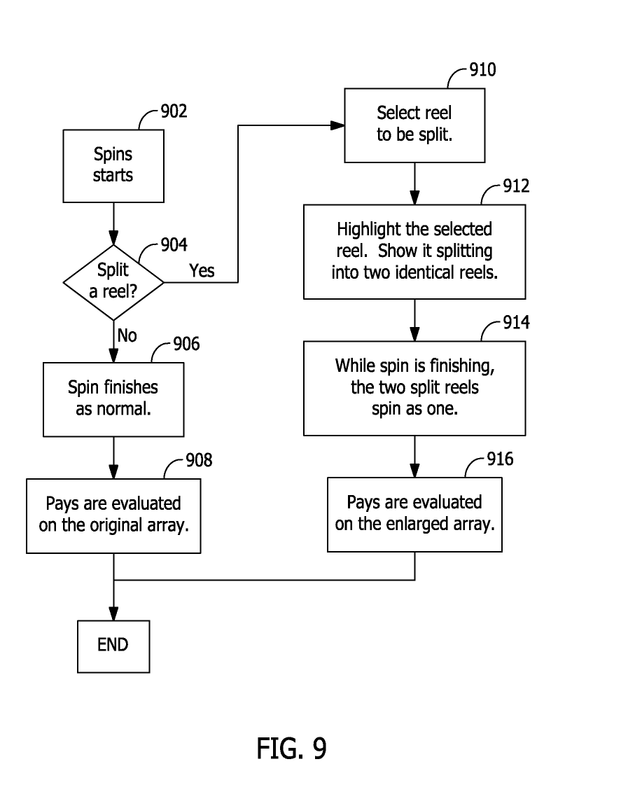

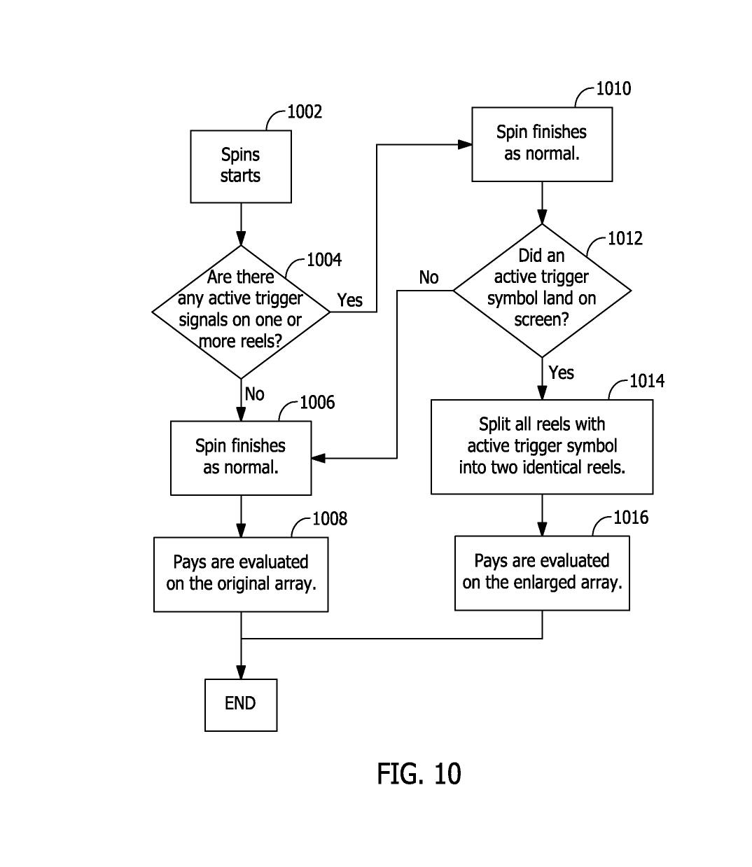

FIGS. 9 and 10 disclose an exemplary flow diagram of an example method of operation. These are but exemplary possible methods of operation and other methods of play are also possible. In the embodiment shown in FIG. 9, after a player has initiated a game, for example by making a wager at a gaming machine, the gaming machine initiates the spinning of the reels in step 902.

In step 904, it is determined whether a reel split feature is initiated on any of the reels. For example, in a five reel array, a random value of possible outcomes from the set {0, 1, 2, 3, 4, 5} is selected. The outcomes may be weighted so that they occur with different probabilities. In this example, an outcome of 0 means that the feature will not be triggered on this spin. Any other outcome means that the corresponding reel will split. For example, if the outcome is 2, the second reel may split.

If the outcome of step 904 is that no reels are to be split, then the process proceeds to step 906. In step 906, the reels finish spinning as in a normal game of slots. Once the reels finish spinning, pays are evaluated according to the displayed symbols on the original array of reels in step 908. The process then ends until a new game is initiated.

If the outcome of step 904 is that a reel is to be slit, then the process proceeds to step 910. In step 910, it is determined which reel is to be split. In the example above, the selected reel may be selected based on the randomly selected outcome of the weighted set of {0, 1, 2, 3, 4, 5}. Other selection methods may also used.

Next, in step 912, the selected reel is highlighted and shown splitting into two identical reels. For example, as shown in FIG. 2, the selected reel 202 is highlighted by an indicator 210. The example shown in FIG. 3 shows the identical reels 302a, 302b. In step 914, the reels finish spinning while the two split reels are displayed to spin as one. In step 916, the pays are evaluated on the enlarged array, and the process ends until a new game is initiated.

Of course, variations of the process may also be used. For example, the determination of whether a reel is to be split may occur prior to the spinning of the reels or after the spinning of the reels. In addition, the reel may split into non-identical reels or identical reels that spin independently. As explained above, more than one reel may be split, or one or more reels may be enlarged in height.

FIG. 10 shows another embodiment of an example method of operation. In FIG. 10, after a game in initiated, such as by a player making a wager at a gaming machine, the reels in a slot game start spinning in step 1002. In this embodiment in step 1004, the gaming machine determines if there are any active trigger symbols on one or more reels. If no trigger symbols are currently active, the spin finishes as normal in step 1006, and the pays for the resulting displayed symbols are evaluated on the original array in step 1008.

If there are active trigger symbols, then the method proceeds to step 1010. In step 1010, the reels finish spinning as normal. In Step 1012, it is determined whether an active trigger symbol landed on the screen. If no active trigger symbol is on the screen, the process proceeds to step 1006 as described above. When an active trigger symbol is on the screen, then the method proceeds to step 1014.

In step 1014, the gaming machine splits the reels that have active trigger symbols into two reels. As shown in FIGS. 5 and 6 as explained above, the split reels may be identical, and the trigger symbol may be reproduced onto each of the split reels in either the same or at a different location on the split reels. Next, in step 1016, the pays are evaluated on the enlarged array, and the process completes until the next game is initiated.

Variations of this process may also be implemented. For example, when the active trigger symbol lands on the screen, the trigger symbol may be overlaid and fixed on a symbol position while the remaining symbols of the reels spin. As another example, the active symbol may split a reel after a pay evaluation for use on a subsequent spin of the reels.

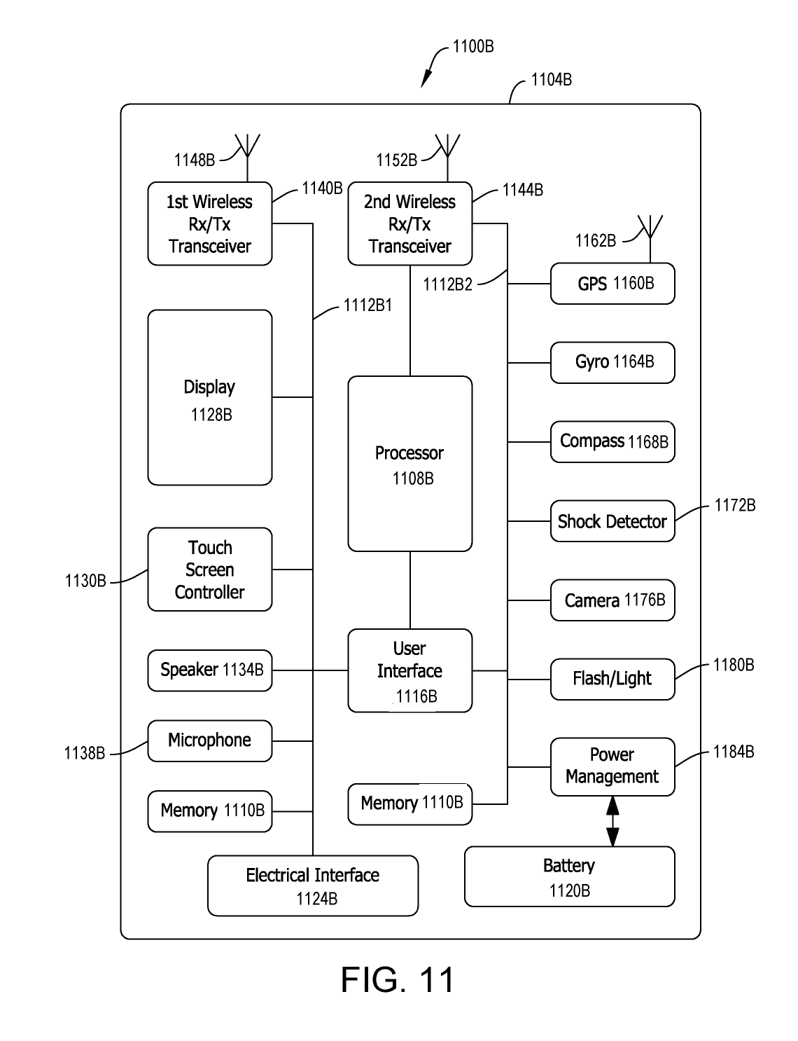

FIG. 11 is an exemplary computer or mobile device 1100B. FIG. 11 illustrates an example embodiment of a mobile device 1100B. This is but one possible device configuration, and as such it is contemplated that one of ordinary skill in the art may differently configure the mobile device. The device 1100B may comprise any type of fixed or mobile communication device that can be configured in such a way so as to function as described below. The mobile device may comprise a PDA, cellular telephone, smart phone, tablet PC, wireless electronic pad, or any other computing device.

In this example embodiment, the mobile device 1100B is configured with an outer housing 1104B that protects and contains the components described below. Within the housing 1104B is a processor 1108B and a first and second bus 1112B1, 1112B2 (collectively 1112B). The processor 1108B communicates over the buses 1112B with the other components of the mobile device 1100B. The processor 1108B may comprise any type of processor or controller capable of performing as described herein. The processor 1108B may comprise a general purpose processor, ASIC, ARM, DSP, controller, or any other type processing device.

The processor 1108B and other elements of the mobile device 1100B receive power from a battery 1120B or other power source. An electrical interface 1124B provides one or more electrical ports to electrically interface with the mobile device 1100B, such as with a second electronic device, computer, a medical device, or a power supply/charging device. The interface 1124B may comprise any type of electrical interface or connector format.

One or more memories 1110B are part of the mobile device 1100B for storage of machine readable code for execution on the processor 1108B, and for storage of data, such as image data, audio data, user data, medical data, location data, shock data, or any other type of data. The memory may store the messaging application (app). The memory may comprise RAM, ROM, flash memory, optical memory, or micro-drive memory. The machine readable code as described herein is non-transitory.

As part of this embodiment, the processor 1108B connects to a user interface 1116B. The user interface 1116B may comprise any system or device configured to accept user input to control the mobile device. The user interface 1116B may comprise one or more of the following: keyboard, roller ball, buttons, wheels, pointer key, touch pad, and touch screen. A touch screen controller 1130B is also provided which interfaces through the bus 1112B and connects to a display 1128B.

The display comprises any type of display screen configured to display visual information to the user. The screen may comprise an LED, LCD, thin film transistor screen, OEL CSTN (color super twisted nematic), TFT (thin film transistor), TFD (thin film diode), OLED (organic light-emitting diode), AMOLED display (active-matrix organic light-emitting diode), capacitive touch screen, resistive touch screen or any combination of these technologies. The display 1128B receives signals from the processor 1108B and these signals are translated by the display into text and images as is understood in the art. The display 1128B may further comprise a display processor (not shown) or controller that interfaces with the processor 1108B. The touch screen controller 1130B may comprise a module configured to receive signals from a touch screen which is overlaid on the display 1128B. Messages may be entered on the touch screen 1130B, or the user interface 1116B may include a keyboard or other data entry device.

Also part of this exemplary mobile device is a speaker 1134B and microphone 1138B. The speaker 1134B and microphone 1138B may be controlled by the processor 1108B and are configured to receive and convert audio signals to electrical signals, in the case of the microphone, based on processor control. Likewise, processor 1108B may activate the speaker 1134B to generate audio signals. These devices operate as is understood in the art and as such are not described in detail herein.

Also connected to one or more of the buses 1112B is a first wireless transceiver 1140B and a second wireless transceiver 1144B, each of which connect to respective antenna 1148B, 1152B. The first and second transceiver 1140B, 1144B are configured to receive incoming signals from a remote transmitter and perform analog front end processing on the signals to generate analog baseband signals. The incoming signal may be further processed by conversion to a digital format, such as by an analog to digital converter, for subsequent processing by the processor 1108B. Likewise, the first and second transceiver 1140B, 1144B are configured to receive outgoing signals from the processor 1108B, or another component of the mobile device 1108B, and up-convert these signal from baseband to RF frequency for transmission over the respective antenna 1148B, 1152B. Although shown with a first wireless transceiver 1140B and a second wireless transceiver 1144B, it is contemplated that the mobile device 1100B may have only one such system or two or more transceivers. For example, some devices are tri-band or quad-band capable, or have Bluetooth and NFC communication capability.

It is contemplated that the mobile device, and hence the first wireless transceiver 1140B and a second wireless transceiver 1144B may be configured to operate according to any presently existing or future developed wireless standard including, but not limited to, Bluetooth, WI-FI such as IEEE 802.11 a,b,g,n, wireless LAN, WMAN, broadband fixed access, WiMAX, any cellular technology including CDMA, GSM, EDGE, 3G, 4G, 5G, TDMA, AMPS, FRS, GMRS, citizen band radio, VHF, AM, FM, and wireless USB.

Also part of the mobile device is one or more systems connected to the second bus 1112B which also interfaces with the processor 1108B. These devices include a global positioning system (GPS) module 1160B with associated antenna 1162B. The GPS module 1160B is capable of receiving and processing signals from satellites or other transponders to generate location data regarding the location, direction of travel, and speed of the GPS module 1160B. GPS is generally understood in the art and hence not described in detail herein.

A gyro 1164B connects to the bus 1112B to generate and provide orientation data regarding the orientation of the mobile device 1104B. A compass 1168B, such as a magnetometer, provides directional information to the mobile device 1104B. A shock detector 1172B, which may include an accelerometer, connects to the bus 1112B to provide information or data regarding shocks or forces experienced by the mobile device. In one configuration, the shock detector 1172B generates and provides data to the processor 1108B when the mobile device experiences a shock or force greater than a predetermined threshold. This may indicate a fall or accident.

One or more cameras (still, video, or both) 1176B are provided to capture image data for storage in the memory 1110B and/or for possible transmission over a wireless or wired link or for viewing at a later time. The processor 1108B may process image data to perform image recognition, such as in the case of, facial detection, item detection, facial recognition, item recognition, or bar/box code reading.

A flasher and/or flashlight 1180B are provided and are processor controllable. The flasher or flashlight 1180B may serve as a strobe or traditional flashlight, and may include an LED. A power management module 1184 interfaces with or monitors the battery 1120B to manage power consumption, control battery charging, and provide supply voltages to the various devices which may require different power requirements.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A gaming machine comprising:
a wager accepting device comprising a coin, bill, or ticket acceptor configured to receive a monetary value at the gaming machine;
at least one electronic display configured to present game information including a wagering game to a player;
at least one player input device that is part of or separate from the display, the player input device configured to accept player input regarding the wagering game;
a controller including one or more random number generators in communication with the player input device, the controller configured to execute machine-readable code;
memory in communication with the controller, the memory configured to store the machine-readable code, the machine readable code executable by the controller and configured to cause the gaming machine to present a wagering game comprising:
receiving a coin, bill, or ticket comprising a monetary value from the player at the gaming machine as credits usable at the gaming machine;
accepting an input from the player via the at least one player input device to accept a wager on a wagering game or enable game play;
presenting a plurality of slot reels on the electronic display, the plurality of slot reels each comprising a plurality of symbols;
determining whether a split feature is triggered in the wagering game via the random number generator;
responsive to the split feature being triggered in the wagering game, splitting one or more of the plurality of slot reels into two or more slot reels;
randomizing an outcome of the symbols on one or more of the plurality of slot reels via the random number generator and displaying the slot reels spinning on the electronic display;
evaluating the symbols on the plurality of slot reels for winning outcomes; and
responsive to a winning outcome providing an award to the player.

2. The gaming machine according to claim 1, wherein the splitting one or more of the plurality of slot reels comprises splitting one or more slot reels into two or more identical slot reels.

3. The gaming machine according to claim 1, wherein the splitting one or more of the plurality of slot reels comprises increasing a height of one or more of the slot reels.

4. The gaming machine according to claim 1, wherein the evaluating the symbols comprises an all way any way pay evaluation.

5. A gaming machine comprising:
a wager accepting device comprising a coin, bill, or ticket acceptor configured to receive a monetary value at the gaming machine;
at least one electronic display configured to present game information including a wagering game to a player;
at least one player input device that is part of or separate from the display, the player input device configured to accept player input regarding the wagering game;
a controller including one or more random number generators in communication with the player input device, the controller configured to execute machine-readable code;
memory in communication with the controller, the memory configured to store the machine-readable code, the machine readable code executable by the controller and configured to cause the gaming machine to present a wagering game comprising:
receiving a coin, bill, or ticket comprising a monetary value from the player at the gaming machine as credits usable at the gaming machine;
accepting an input from the player via the at least one player input device to accept a wager on a wagering game or enable game play;
presenting a plurality of slot reels on the electronic display, the plurality of slot reels each comprising a plurality of symbols, the plurality of symbols comprising one or more trigger symbols;
randomly assigning the one or more trigger symbols an active or an inactive status via the random number generator;
randomizing an outcome of the symbols on the plurality of slot reels via the random number generator and displaying the slot reels spinning on the electronic display;
when the one or more trigger symbols that has the active status is displayed on the electronic display as a result of the randomizing, splitting the slot reel on which the active trigger symbol is displayed into two or more slot reels;
evaluating the symbols on the plurality of slot reels for winning outcomes; and
when winning outcomes are evaluated, providing an award to the player for a winning outcome, the award based on the wager amount.

6. The gaming machine according to claim 5, wherein the splitting the slot reel comprises splitting the slot wheel on which the active trigger symbol is displayed into two or more identical slot reels.

7. The gaming machine according to claim 5, wherein the splitting the slot reel comprises increasing a height of the slot wheel on which the active trigger symbol is displayed.

8. The gaming machine according to claim 5, wherein the evaluating the symbols comprises an all way any way pay evaluation.

9. The gaming machine according to claim 5, wherein the active trigger symbol is reproduced on each reel resulting from splitting the slot reel on which the active trigger symbol is displayed.

10. The gaming machine according to claim 9, wherein the active trigger symbol is reproduced at a different location on each reel resulting from the splitting.

11. The gaming machine according to claim 5, wherein when an active trigger symbol is displayed on the electronic display, the active trigger symbol is overlaid and fixed on a symbol position while remaining symbols of the reels spin.

12. A method of presenting a game on a gaming machine comprising at least one electronic display, a wager accepting device, at least one player input device, and a controller including at least one random number generator, the method comprising:
receiving a wager from a player at the gaming machine via the wager accepting device;
accepting an input from the player via the at least one player input device to accept a wager on a wagering game or enable game play;
presenting a plurality of slot reels on the electronic display, the plurality of slot reels each comprising a plurality of symbols;
determining whether a split feature is triggered in the wagering game via the random number generator;
when the split feature is triggered in the wagering game, splitting one or more of the plurality of slot reels into two or more slot reels;
randomizing an outcome of the symbols on the plurality of slot reels via the random number generator and displaying the slot reels spinning on the electronic display;
evaluating the symbols on the plurality of slot reels for winning outcomes; and
when winning outcomes are evaluated, providing a monetary award to the player for the winning outcomes based on the wager amount.

13. The method of presenting a game on a gaming machine according to claim 12, wherein the controller selects the split feature for none or one or more of the plurality of slot reels based on an outcome generated by the random number generator.

14. The method of presenting a game on a gaming machine according to claim 12, wherein the plurality of symbols comprises one or more trigger symbols, and when the one or more trigger symbols are displayed on one of the plurality of slot reels, the split feature is applied to each of the slot reels displaying the trigger symbol.

15. The method of presenting a game on a gaming machine according to claim 14, wherein the one or more trigger symbols are randomly assigned an active or an inactive status, and applying the split feature only where the trigger symbol is assigned the active status.

16. The method of presenting a game on a gaming machine according to claim 12, wherein the splitting one or more of the plurality of slot reels comprises splitting one or more slot reels into two or more identical slot reels.

17. The method of presenting a game on a gaming machine according to claim 12, wherein the splitting one or more of the plurality of slot reels comprises increasing a height of one or more of the slot reels.

18. The method of presenting a game on a gaming machine according to claim 12, wherein the evaluating the symbols comprises an all way any way pay evaluation.
